(19) United States
(12) Patent Application Publication
(10) Pub. No.: US 2026/0063367 A1
(43) Pub. Date: Mar. 5, 2026

(54) Apparatus and Method for Flame Control to Melt Metal

(71) Applicant: Air Products and Chemicals, Inc., Allentown, PA (US)

(72) Inventors: Eric R. Seo, Bowmanstown, PA (US); Reed Jacob Hendershot, Mesa, AZ (US); Anandkumar Makwana, Breinigsville, PA (US); Valmiro Correia Sa, Magnolia, TX (US)

(73) Assignee: Air Products and Chemicals, Inc., Allentown, PA (US)

(21) Appl. No.: 18/911,002

(22) Filed: Oct. 9, 2024

Related U.S. Application Data
(60) Provisional application No. 63/687,814, filed on Aug. 28, 2024.

(51) Int. Cl. F27D 21/02; F27D 19/00

(52) U.S. Cl. CPC F27D 21/02; F27D 19/00

(57) ABSTRACT

An apparatus, system, and process for melting a metal can be configured to utilize a scheme for flame control to improve heating of scrap metal while also avoid flame impingement on liquified metal. Embodiments can utilize one or more sensors to detect a solid or liquid state of the metal to be melted and adjust the flame (e.g. adjust the length and/or direction of the flame) output from one or more burners of a furnace to account for the detected state of the metal.

### CROSS-REFERENCE TO RELATED APPLICATIONS

The present application claims priority to U.S. Provisional Patent Application No. 63/687,814, filed on Aug. 28, 2024 and is incorporated herein by reference.

### FIELD OF THE INVENTION

The present innovation relates to processes and apparatuses to melt metal (e.g. reverberatory furnaces, etc.) and processes and apparatuses to control flame(s) for the melting of metal (e.g. melting of scrap aluminum or other scrap metal, etc.).

### BACKGROUND OF THE INVENTION

Furnaces can often use burners to generate a flame for heating. The heat that is provided can be used in various industrial processes. For example, reverberatory furnaces and rotary furnaces can often use one or more burners to generate a flame for heating metal in a bath region of the furnace. Examples of furnaces and burners can be appreciated from U.S. Pat. App. Pub. Nos. 2019/0360067 and 2021/0116125 and U.S. Pat. Nos. 7,390,189, 8,696,348, 8,727,767, 8,806,897, 9,134,025, 9,360,257, 9,657,945, 9,689,312, 9,976,721, 10,584,051, 11,441,206, and 11,598,522.

### SUMMARY OF THE INVENTION

We determined that burner operation and furnace operation for the melting of metal can result in overheating of the metal or the burning of the metal. This can occur, for example, during a remelt operation for melting of scrap, melting of metal for recycling of the metal, melting of aluminum scrap for recycling of the aluminum, or other types of metal melting applications. Burning of metal (e.g. aluminum) can result in oxidation of the metal. For instance, in melting of aluminum, if the metal is oxidized, the aluminum (Al) can be converted to alumina (Al₂O₃), which can result in a loss of yield and increased waste. The decrease in operational efficiency and lost yield can also result in lower profitability associated with operation of a melting process.

For example, in a reverberatory furnace utilized for aluminum recycling, yield recovery and energy costs can be significant factors that affect furnace operational efficiency and productivity. Yield recovery for aluminum recycling can be the amount of aluminum obtained from metaling scrap material that includes aluminum. If the scrap is overheated either overall or in specific areas, this can burn the aluminum causing oxidization and converting it to alumina, which results in a loss of yield, increased waste, and lower profitability. The input energy used to cause this loss in yield could also increases the total energy costs and results in the less efficient utilization of heat, which can result in an increased environmental impact associated with operation of a furnace.

We determined that it can be beneficial to control operation of a furnace so that flame(s) output by one or more burners of a furnace can be controlled to provide greater flexibility in operation of the furnace for a more refined control of melting of metal to help avoid burning the metal while also improving utilization of energy so that a more efficient and flexible operation of the furnace can be provided in a way that may also improve the environmental impact related to operation of the furnace and the melting of metal.

Embodiments of a furnace, a process for melting metal, a process for controlling burner operation, and a control system for melting of metal via a furnace and/or a metal melting process can be provided. Embodiments can facilitate improved operation of one or more burners to account for a material state of the metal being melted to more effectively utilize heat generated via combustion of a fuel provided via the burner(s).

The burners that may be utilized in the furnace can be any type of suitable burner. For example, burners, oxy-fuel burners, transient burners with multiple burner elements wherein each burner element can output a respective flame, or a combination of such burners can be utilized.

The metal material to be melted can be aluminum or another type of metal or can be an alloy (e.g. brass or bronze). For example, the metal material can be copper, lead, tin, brass, steel, iron, or other suitable metal material instead of aluminum.

In some embodiments, improved heat distribution throughout the furnace with increased heat transfer by convection surface turbulence can be provided when the metal material is still solid in a first operational cycle. As the metal material increases in temperature a material state change can occur (e.g. for aluminum, the material state change can occur around 660° C., etc.). With continued heating a semi-flat surface of molten aluminum can be formed as the solid metal material begins to melt. After the molten state of the metal is detected (e.g. a detection of a relatively semi-flat surface is detected), a material state change can be determined to have occurred based on this detection. Such a detection can occur via at least one ultrasound sensor, at least one imaging sensor (e.g. at least one camera), or other type of sensor or combination of sensors (e.g. use of a temperature sensor, use at least one temperature sensor at a pre-selected position for measuring temperature at a particular location in the furnace, etc.). Once this material state change is detected, the operation of the burner(s) can be adjusted to change the flame position of the flame(s) above the metal material. An adjustment in operation of the burner(s) can occur again after the metal material is determined to have fully melted such that there is a relatively flat surface of the metal material in the bath of the furnace. The adjustment in the operation of the burner(s) can adjust the length of the flame, the direction of the flame, and/or the firing rate of the burner(s) to account for the material state of the metal material being melted to help avoid burning of the metal material while also providing improved use of the heat of the generated flame(s).

For example, burner operation can be adjusted so that each of the burners operates so that heat energy continues to enter the furnace during the melting operation, but a high flame velocity is removed from the surface of the material there by reducing the surface rippling and reducing oxidation of the liquid aluminum or other metal by reducing mixing and heat flux. The flame movement can be mechanical, or valve operated with movement in all directions in some embodiments. The movement of the flame(s) can reduce over heating of the metal material (e.g. avoid burning of the metal), reduce surface rippling, reduce cycle time, and reduce energy wasted in overheating the material leading to an increase in yield recovery, reduced waste production, and improved time savings (e.g. allowing a melting operation to occur more quickly).

In some embodiments, scrap metal material can be initially heated in a first cycle of operation via at least one burner outputting a flame (e.g. via combustion of a fuel in the presence of an oxidant) at a first firing rate, which can be set to be a high firing rate. This can help improve heat distribution throughout the furnace with increased heat transfer by convection surface turbulence occurring when the metal material is still solid. As the material increases in temperature a material state change can occur. For aluminum, the state change may occur around 660° C. (e.g. 660° C.+/−25° C.) or at 660° C., for example depending on the alloy. With continued heating during this first operational cycle, the metal material can melt into a more molten state that can create a semi-flat surface of molten aluminum in the furnace.

Once this semi-flat surface or near molten condition is detected via at least one sensor, a material state change is determined to have occurred and the operation of the burner(s) can be adjusted to a second cycle of operation. For example, after this material state change is detected, the burner(s) can be adjusted to change the flame position away from the metal material and operates at the current or reduced firing rate until the metal material is fully melted. This adjustment could result in moving the flame(s) from near the entrance of a furnace to near the exit of the furnace, moving the flame(s) side to side, shortening the flame, elongating the flame, and/or any combination of these movements at the current or reduced firing rate until the cycle is complete and the metal is melted and or heated to its desired temperature. Heat energy can continue to enter the furnace via the flame(s) but the flame position adjustment can permit the distribution of the heat and the flame positioning to reduce oxidation of the liquid aluminum or other metal charge material. The flame movement can be mechanical, or valve operated with movement in any desired direction depending on the burner position for each burner and the detected state or position of the metal material being melted.

The second cycle of operation in which the burner(s) operation is adjusted can be performed until the metal material is fully melted into a liquid or can be performed until another detected state change has occurred in which the metal material is detected as being further melted to another molten state that is more liquified, but not yet fully liquid metal. In response to such a detected change, which can occur via at least one sensor, the burner(s) can be adjusted for operating in a third cycle of operation. For example, the operation of the burner(s) can be adjusted to change the flame position further away from the metal material and operate at the current or reduced firing rate until the metal material is more fully melted or is entirely melted. This adjustment could result in moving the flame(s) from the entrance of a furnace to the exit of the furnace, moving the flame(s) side to side, shortening the flame, elongating the flame, and/or any combination of these movements at the current or reduced firing rate until the cycle is complete and the metal is melted. Heat energy can continue to enter the furnace via the flame(s) but the flame position adjustment can permit the distribution of the heat and the flame positioning to reduce oxidation of the liquid aluminum. The flame movement can be mechanical, or valve operated with movement in any desired direction depending on the burner position for each burner and the detected state or position of the metal material being melted.

Burners can operate for heating and melting of metal material within a pre-selected range of equivalence ratios. The equivalence ratio utilized can also change over time as the melting is performed to account for various factors (e.g. temperature, melted state of the metal material, etc.). The equivalence ratio settings utilized for burners can also be different for different burners to account for where the burners are located relative to the material to be melted.

For instance, the equivalence ratio for burner(s) and/or burner element(s) located closer to the metal material to be melted in a bath can range from 0.5 to 5, 0.95 to 5 or 1 to 3.75 in different embodiments, for example. At the beginning of a melt operation (e.g. at an initial phase in which the metal material is solid state), a higher equivalence ratio may be utilized (e.g. an equivalence ratio of 5, 3.75, or other value at a higher end of a pre-selected operational range of equivalence ratios). At the end of a melt operation in which the metal material is liquified, a lower equivalence ratio may be utilized (e.g. an equivalence ratio of 0.5, 0.95, 1.0, or other value at a lower end of a pre-selected operational range of equivalence ratios).

For burner(s) and/or burner element(s) that are farther away from the metal material to be melted (e.g. closer to a roof of the bath, etc.) the equivalence ratio for burner(s) and/or burner element(s) can range from 0.1 to 1, 0.25 to 1 or 0.2 to 1 in different embodiments, for example. At the beginning of a melt operation (e.g. at an initial phase in which the metal material is solid state), a lower equivalence ratio may be utilized (e.g. an equivalence ratio of 0.1, 0.2, 0.25, 0.36, 0.4, or other value at a lower end of a pre-selected operational range of equivalence ratios). At the end of a melt operation in which the metal material is liquified, a higher equivalence ratio may be utilized (e.g. an equivalence ratio of 1, 0.9, 0.95, or other value at a higher end of a pre-selected operational range of equivalence ratios).

The burners and/or burner elements can also be operated such that the equivalence ratio of all burner(s) and/or burner elements utilized in the melting of the metal material can operate at an overall combined equivalence ratio within a pre-selected range of ratios (e.g. an overall combined equivalence ratio range of 1-1.1, 0.9-1.2, 0.95-1.15, etc.). The selected operational equivalence ratios can be selected to account for bath and furnace configurations, fuel to be combusted, the type of metal material to be melted, and the presence of any combustible contaminants.

Burner and/or burner element firing rates can also be pre-selected to account for where the burner(s) and/or burner element(s) are located relative to the material to be melted and other design and operational objectives. For instance, for burner(s) and/or burner element(s) located closer to the metal material to be melted in a bath, their firing rate can be within a pre-selected range of 10%-90%, 50%-90% or 70%-80% of the overall furnace combined firing rate of all burners, for example. At the beginning of a melt operation (e.g. at an initial phase in which the metal material is solid state), a higher firing rate allocation may be utilized (e.g. firing rate allocation of 70%-80%, or 50%-90%, or other value at a higher end of a pre-selected operational range of firing rate allocations). At the end of a melt operation in which the metal material is liquified, a lower firing rate allocation may be utilized (e.g. a firing rate of 20%-30%, 10%-50%, or other value at a lower end of a pre-selected operational range of firing rates).

For burner(s) and/or burner element(s) that are farther away from the metal material to be melted (e.g. closer to a roof of the bath, etc.) the range of firing rate allocations for such burner(s) and/or burner element(s) can range from 10% to 90%, 20%-80%, or other pre-selected firing rate allocation range of the overall furnace firing rate in different embodiments, for example. At the beginning of a melt operation (e.g. at an initial phase in which the metal material is solid state), a lower firing rate allocation may be utilized (e.g. a firing rate allocation of 20%-30%, a firing rate of 10%-50%, or other value at a lower end of a pre-selected operational range of firing rate allocations). At the end of a melt operation in which the metal material is liquified, a higher firing rate allocation may be utilized (e.g. firing rate of 70%-80%, 50%-90%, or other value at a higher end of a pre-selected operational range of firing allocation ratios).

At or near the end of a melting operation in which the metal material is liquified, the firing rate may decrease further as the end of the melt operation approaches. And the firing of the burners can also, in some embodiments, be ceased after a full melt has occurred in some embodiments.

Embodiments can be configured for utilization in conjunction with any number of different arrangements of burners. For example, embodiments can be configured so that an array of burners in the furnace that are controlled include a number of different spaced apart burners that are positioned on sidewalls of the furnace. As another example, embodiments can be configured so that an array of burners in the furnace that are controlled include a number of different spaced apart burners that are positioned on a roof or ceiling of the furnace. As yet another example, embodiments can be so that an array of burners in the furnace that are controlled include a number of different spaced apart burners in which one or more of the burners are positioned on one or more sidewalls and at least one other burner is positioned on a roof or ceiling of the furnace.

Embodiments can be configured to utilize different types of material state change detection mechanism or utilize different detection schemes for determining a material state of the metal material for triggering an adjustment in operation of one or more burners. Some embodiments can utilize one or more sensors that can facilitate a detection of one or more parameters related to the material state change of the metal material. For example, one or more sensors can detect taller and shorter regions of metal material in the furnace (e.g. via a detection of a weight distribution of the metal material in the furnace, ultrasound detection of the surface of the metal material being melted, pressure measurements, use of a laser or other optical sensor to detect a height distribution of the metal material in the furnace, ultrasound detection of the metal material to detect the heights of different regions of the metal material in the furnace, camera(s) to optically determine surfaces of the metal material in the furnace, and/or a combination of these sensor approaches, etc.). Data from one or more sensors can be provided to a controller that can evaluate the sensor data based on a pre-defined evaluation scheme for use in detection of a material state change. A controller or other type of computer device can be utilized to implement this pre-defined evaluation scheme. For example, the pre-defined evaluation scheme can be performed via a computer device that utilizes a static or machine learning model. A machine learning model can consist of but not limited to a convolutional neural network (CNN) and/or other neural network(s) for image processing and/or classification. A machine learning model can also consist of but not limited to other statistical methods such as clustering and/or regression for data processing and prediction. In response to a detected material state change that is based on the sensor data and/or model, the controller can adjust operation of the burner(s).

In some embodiments, the detecting of the material change in state of the metal material can utilize one or more sensors that detect a liquid level, laser sensor(s), ultrasonic sensor(s), images in visible and/or infra-red light captured via at least one camera, bubbler pressure of furnace sensor(s), temperature changes of the furnace or of the metal via one or more temperature sensors, flue gas temperature via one or more temperature sensors, composition changes via one or more compositional detection sensors or composition analyzers, weight distribution of the metal material in the furnace and/or pressure distribution of the furnace via one or more sensors. The material state change determinations can be based on either absolute changes, changes in the trends of the measurement data provided via the sensor(s), or changes in imagery data.

In some embodiments, the detection of the material change in state of the metal material can utilize a model that is stored in non-transitory memory of a controller and is run by a processor of the controller. The model can be run using sensor data from one or more sensors received by the controller to predict the change in state of the metal material (e.g. from entirely solid to at least partially liquid, from a partially liquid state to an entirely liquid state, etc.). The controller can detect the metal material being in a changed state based on running the model to predict the change in material state of the metal material to trigger adjustment in operation of the burner(s). Parameters of the model can be periodically updated via a historian device or controller evaluation device that may be communicatively connectable to the controller as well for updating of the model utilized for detection of change in state of the metal material for adjusting operation of the burner(s).

In a first aspect, a process for melting metal material includes directing at least one flame to metal material in a bath such that the at least one flame impinges the metal material or is within a pre-selected distance that is no greater than 2 meters from the metal material while an entirety of the metal material is in a solid state and, in response to detecting that the metal material has melted such that the metal material is at least in a partially liquid state, adjusting the at least one flame to move the at least one flame away from the metal material.

Embodiments can be implemented so that when the metal material is in an entirely solid state, it can be in a pile in the bath 2 that may have at least one apex of height that may be a tallest surface of an upper surface of the metal material within the bath. When the metal material is entirely solid, it can be a new batch of metal material to be melted that is entirely solid. In the event a small portion of liquid metal from a prior batch remains in the bath, the metal material may still be considered entirely solid because the new batch added for melting is entirely solid and makes up a majority of the metal to be melted in the bath. The small portion of liquid metal from a prior batch that may remain in such situations can be dependent on the furnace and burner configuration that may be utilized. In some embodiments, this remaining small portion of molten material (if present) can be greater than 0 weight percent (wt %) of the metal material in the bath to less than 40 wt % of the metal material in the bath, between 0 wt % and 30 wt % of the metal material in the bath, between 0 wt % and 20 wt % of the metal material in the bath, between 0 wt % and 10 wt % of the metal material in the bath, or between 0 wt % and 5 wt % of the metal material in the bath.

In a second aspect, the adjusting of the at least one flame to move the at least one flame away from the metal material can include shortening of the at least one flame to avoid burning of the metal material, adjusting a firing rate of the at least one burner that outputs the at least one flame, and/or adjusting operation of the at least one burner so that the at least one flame extends horizontally relative to an upper surface of the metal material and above the upper surface. Other embodiments may also utilize one or more other flame adjustment approaches.

In some embodiments, the adjusting of the at least one flame to move the at least one flame away from the metal material can include adjusting operation of at least one burner that outputs the at least one flame such that the at least one flame extends at an angle of inclination away from an upper surface of the metal material.

In other embodiments, the adjusting of the at least one flame to move the at least one flame away from the metal material can include adjusting operation of at least one burner that outputs the at least one flame so that the at least one flame extends horizontally relative to an upper surface of the metal material and above the upper surface.

In a third aspect, the process can be performed so that, in response to detecting that the metal material has melted such that the metal material is in a first intermediate stage of melting in which a portion of the metal material is in a liquid state and a portion of the metal material is in a solid state, the at least one flame is adjusted such that the at least one flame is moved away from a lower portion of an upper surface of the metal material and is directed toward a taller region of the upper surface of the metal material that is determined to be the portion of the metal material that is in the solid state for the first intermediate stage of melting.

In some embodiments, the process can also be performed so that, in response to detecting that the metal material has melted such that the metal material is in a second intermediate stage of melting in which a portion of the metal material is in a liquid state and a portion of the metal material is in a solid state, the at least one flame is adjusted such that the at least one flame is directed toward a taller region of an upper surface of the metal material that is determined to be the portion of the metal material that is in the solid state for the second intermediate stage of melting. In such embodiments, the portion of the metal material that is in the liquid state can differ in size as compared to the portion of the metal material that is in the liquid state of the first intermediate stage of melting (e.g. in the second intermediate stage of melting there may be more liquid metal material as compared to the first intermediate stage of melting).

In a fourth aspect, the process can include detecting that the metal material has melted such that the metal material is entirely in the liquid state. The detecting that the metal material has melted such that the metal material is entirely in the liquid state can include a controller receiving data from at least one sensor positioned to detect the metal material has melted such that the metal material is entirely in the liquid state. In some embodiments, the at least one sensor can include at least one ultrasound sensor and/or at least one camera. Other sensors may also (or alternatively) be utilized.

In some embodiments, the process can also include detecting that the metal material has melted such that the metal material is entirely in the liquid state based on determining that an upper surface of the metal material within a bath is of a uniform height. Examples of such embodiments can also include other intermediate steps or stages. For instance, in some embodiments, the process can include detecting that the metal material has melted such that the metal material is in a first intermediate stage of melting in which a portion of the metal material is in a liquid state and a portion of the metal material is in a solid state based on a determination that an upper surface of the metal material has changed and has a non-uniform height that includes different peaks of different heights and at least one valley between the different peaks. In response to detecting that the metal material has melted such that the metal material is in the first intermediate stage of melting, the at least one flame can be adjusted such that the at least one flame is moved away from a lower portion of an upper surface of the metal material and is directed toward a taller region of the upper surface of the metal material that is determined to be the portion of the metal material that is in the solid state for the first intermediate stage of melting. In some other embodiments, the process can also be implemented so that, in response to detecting that the metal material has melted such that the metal material is in a second intermediate stage of melting in which a portion of the metal material is in a liquid state and a portion of the metal material is in a solid state, the at least one flame is adjusted such that the at least one flame is directed toward a taller region of an upper surface of the metal material that is determined to be the portion of the metal material that is in the solid state for the second intermediate stage of melting. In such embodiments, the portion of the metal material that is in the liquid state can differ in size (e.g. volume and mass) as compared to the portion of the metal material that is in the liquid state of the first intermediate stage of melting (e.g. in the second intermediate stage of melting there may be more liquid metal material as compared to the first intermediate stage of melting).

In a fifth aspect, the process of the first aspect can include one or more features of the second aspect, third aspect, and/or fourth aspect. Embodiments of the process can also include other process steps and/or utilization of an embodiment of an apparatus for melting metal material. Examples of other embodiments of the process can be appreciated from the discussion of exemplary embodiments of the process provided herein.

In a sixth aspect, an apparatus for melting metal material can include a bath having a bottom and a plurality of sidewalls extending above the bath. The apparatus can also include at least one sensor positioned to monitor metal material that is positionable in the bath to collect data related to melting of the metal material in the bath. At least one burner can be posited adjacent to the bath to output at least one flame for melting of the metal material that is positionable in the bath. A controller having a processor connected to a non-transitory computer readable medium can also be included in the apparatus. The controller can be communicatively connectable to the at least one sensor and the at least one burner. The controller can be configured to control operation of the at least one burner so that the least one flame impinges an upper surface of the metal material or is within a pre-selected distance that is no greater than 2 meters from the upper surface of the metal material within the bath while an entirety of the metal material is in a solid state. The controller can also be configured to determine that the metal material has melted such that the metal material is entirely in a liquid state based on sensor data received from the at least one sensor, and, in response to determining that the metal material is entirely in the liquid state, control operation of the at least one burner to adjust the at least one flame to move the at least one flame away from the metal material.

In some embodiments, the controller can be configured to control operation of the at least one burner so that the least one flame impinges an upper surface of the metal material or is within a pre-selected distance that is no greater than 1 meter from the upper surface of the metal material within the bath while an entirety of the metal material is in a solid state (e.g. a distal end of the flame can be within a range of 0-1 meter from the upper surface of the metal material). In other embodiments, the controller can be configured to control operation of the at least one burner so that the least one flame impinges an upper surface of the metal material or is within a pre-selected distance that is no greater than 0.5 meters from the upper surface of the metal material within the bath while an entirety of the metal material is in a solid state (e.g. a distal end of the flame can be within a range of 0-0.5 meters from the upper surface of the metal material).

In some embodiments, the controller can have a pre-defined model stored in its non-transitory memory or other type of non-transitory computer readable medium that is accessible to the processor of the controller to run the model. The processor can run the model utilizing sensor data from one or more sensors to predict when the metal material has sufficiently melted to trigger an adjustment in operation of the burner(s). For example, the controller can determine that the metal material has melted from an entirely metal state to a partially melted state to trigger a first adjustment in operation of the burner(s) and can subsequently determine that the metal material has melted so that the metal material is entirely liquid to trigger a second adjustment in operation of the burner(s) via running of the model using the sensor data received from the sensor(s).

In a seventh aspect, the controller can be configured to control operation of the at least one burner to adjust the at least one flame to move the at least one flame away from the metal material via shortening of the at least one flame to avoid burning of the metal material, adjusting a firing rate of the at least one burner, and/or adjusting operation of the at least one burner so that the at least one flame extends horizontally relative to the upper surface of the metal material and above the upper surface. For example, in some embodiments the controller can be configured to control operation of the at least one burner to adjust the at least one flame to move the at least one flame away from the metal material via adjusting operation of at least one burner so that the at least one flame extends at an angle of inclination away from the upper surface of the metal material. As another example, in some embodiments the controller can be configured to control operation of the at least one burner to adjust the at least one flame to move the at least one flame away from the metal material via adjusting operation of at least one burner so that the at least one flame extends horizontally relative to the upper surface of the metal material and above the upper surface.

In an eighth aspect, the controller can also be configured so that, in response to detecting that the metal material has melted such that the metal material is in a first intermediate stage of melting in which a portion of the metal material is in a liquid state and a portion of the metal material is in a solid state, operation of the at least one burner is adjusted such that the at least one flame is moved away from a lower portion of an upper surface of the metal material and is directed toward a taller region of the upper surface of the metal material that is determined to be the portion of the metal material that is in the solid state for the first intermediate stage of melting. In some embodiments, the controller can also be configured so that, in response to detecting that the metal material has melted such that the metal material is in a second intermediate stage of melting in which a portion of the metal material is in a liquid state and a portion of the metal material is in a solid state, operation of the at least one burner can be adjusted such that the at least one flame is directed toward a taller region of the upper surface of the metal material that is determined to be the portion of the metal material that is in the solid state for the second intermediate stage of melting. The portion of the metal material that is in the liquid state can differ in size as compared to the portion of the metal material that is in the liquid state of the first intermediate stage of melting (e.g. there can be a greater mass and/or volume of metal material in the liquid state in the second intermediate stage of melting as compared to the first intermediate stage of melting).

In a ninth aspect, the at least one sensor can include a single sensor or a plurality of sensors. In some embodiments, the at least one sensor can include at least one ultrasound sensor and/or at least one camera.

In a tenth aspect, the controller can be configured to detect that the metal material has melted such that the metal material is entirely in the liquid state based on determining that the upper surface of the metal material within the bath is of a uniform height.

In an eleventh aspect, an embodiment of the apparatus of the sixth aspect can include one or more features of the seventh aspect, eighth aspect, night aspect, and/or tenth aspect. Embodiments of the apparatus can also include other features or elements. Examples of other embodiments of the apparatus can be appreciated from the discussion of exemplary embodiments of the apparatus provided herein.

In a twelfth aspect, a control system is provided. Embodiments of the control system can be configured to be included in an embodiment of the apparatus for melting metal material and/or implement an embodiment of the process for melting metal material. The control system can include a controller having a processor connected to a non-transitory computer readable medium (e.g. non-transitory memory). The controller can be communicatively connectable to the at least one sensor and at least one burner positioned to output at least one flame to melt metal material. The controller can be configured to control operation of the at least one burner so that the least one flame impinges an upper surface of the metal material or is within a pre-selected distance that is no greater than 2 meters from the upper surface of the metal material while an entirety of the metal material is in a solid state. The controller can also be configured to determine that the metal material has melted such that the metal material is entirely in a liquid state based on sensor data received from the at least one sensor, and, in response to determining that the metal material is entirely in the liquid state, control operation of the at least one burner to adjust the at least one flame to move the at least one flame away from the metal material.

Some embodiments of the control system can also include a control evaluation device communicatively connectable to the controller. The control evaluation device can have a processor connected to a non-transitory computer readable medium. The control evaluation device can be configure to evaluate operational data from melting of metal material that occurred in prior melting operations based on at least one pre-defined control evaluation scheme to identify one or more control parameter adjustments and communicate data to adjust the one or more control parameters to be utilized by the controller based on results from implementation of the at least one pre-defined control evaluation scheme indicating that the one or more control parameter adjustments will improve yield, increase production, and/or reduce energy consumption for melting of the metal material.

Embodiments of the control system can also include other features or elements. Examples of other embodiments of the control system can be appreciated from the discussion of exemplary embodiments of the control system provided herein.

Further, embodiment of the apparatus for melting metal material can also include an embodiment of the control evaluation device.

Embodiments of the process for melting metal material can also include utilization of the control evaluation device. For instance, embodiments of the process can include evaluating operational data from melting of metal material that occurred in prior melting operations based on at least one pre-defined control evaluation scheme to identify one or more control parameter adjustments and communicating data to adjust the one or more control parameters to be utilized by a controller based on results from implementation of the at least one pre-defined control evaluation scheme indicating that the one or more control parameter adjustments will improve yield, increase production, and/or reduce energy consumption for melting of the metal material.

Embodiments of the process, apparatus, and control system can also include other features or elements. Yet other details, objectives, and advantages of an apparatus to melt metal, a process for melting metal, an apparatus to control the flame(s) used for melting of metal, and processes for controlling at least one flame for the melting of metal, and methods of making and using the same will become apparent as the following description of certain exemplary embodiments thereof proceeds.

### BRIEF DESCRIPTION OF THE DRAWINGS

Exemplary embodiments of an apparatus to melt metal, a process for melting metal, an apparatus to control the flame(s) used for melting of metal, and processes for controlling at least one burner for the melting of metal, and methods of making and using the same are shown in the drawings included herewith. It should be understood that like reference characters used in the drawings may identify like components.

FIG. 1 is a schematic diagram of a first exemplary embodiment of an apparatus 1 for melting of metal. The embodiment of the apparatus 1 can include an exemplary embodiment of a control system for controlling at least one flame utilized to melt the metal.

FIG. 2 is a schematic end view of the bath of the first exemplary embodiment of the apparatus 1 with metal material in the bath in an entirely solid state.

FIG. 3 is a schematic end view of the bath of the first exemplary embodiment of the apparatus 1 with metal material in the bath in an entirely liquid state.

FIG. 4 is a schematic view similar to FIGS. 2 and 3 with the metal material shown in a first intermediate state in which the metal to be melted is partially liquified and is also partially solid.

FIG. 5 is a schematic view similar to FIGS. 2, 3, and 4 with the metal material shown in a second intermediate stage of melting in which the metal to be melted is partially liquified and is also partially solid.

FIG. 6 is a schematic end view of the bath of the first exemplary embodiment of the apparatus 1 with metal material in the bath in an entirely solid state.

FIG. 7 is a schematic end view of the bath of the first exemplary embodiment of the apparatus 1 with metal material in the bath in an entirely liquid state.

FIG. 8 is a schematic end view of the bath of the first exemplary embodiment of the apparatus 1 with metal material in the bath in an entirely solid state.

FIG. 9 is a schematic end view of the bath of the first exemplary embodiment of the apparatus 1 with metal material in the bath in an entirely liquid state.

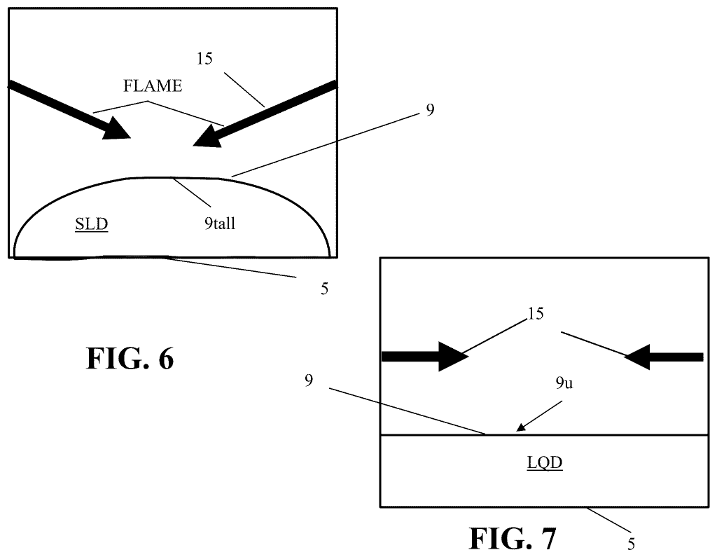

FIG. 6 is a schematic end view of the bath of the first exemplary embodiment of the apparatus 1 with metal material in the bath in an entirely solid state.

FIG. 10 is a block diagram of the first exemplary embodiment of the control system CS of the first exemplary embodiment of the apparatus 1 with metal material in the bath in an entirely liquid state.

FIG. 11 is a flow chart illustrating a first exemplary embodiment of a process for melting metal, which can utilize an exemplary embodiment of a process for controlling at least one flame for the melting of metal. Embodiments of the apparatus 1 can be configured to utilize an embodiment of these processes.

FIG. 12 is a graph illustrating exemplary melting condition parameters that can be evaluated for updating control parameter settings of a controller CTRL for control of operations of an apparatus 1 for melting of metal.

### DETAILED DESCRIPTION

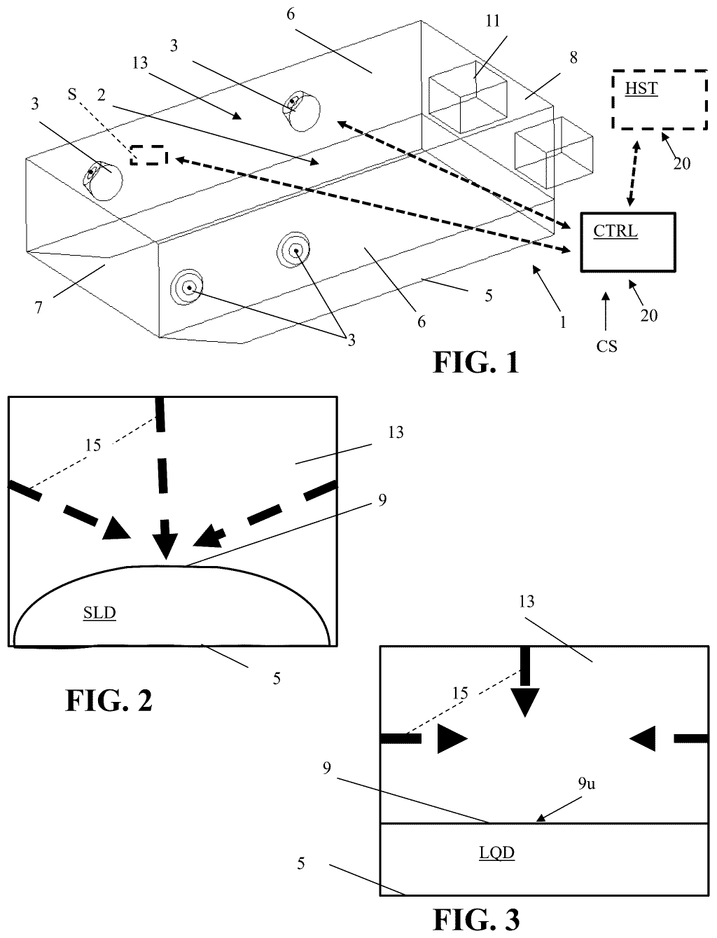

Referring to FIGS. 1-11, an apparatus 1 for melting of metal material can be configured as a reverberatory furnace (which can also be referred to as a reverb furnace) or other type of suitable furnace. The apparatus 1 can include a housing that has a bath 2. The bath can be defined by a structure of the apparatus that includes sidewalls that extend from a bottom 5. For example, there can be a font wall 7, a rear wall 8, and spaced apart walls 6 that extend along opposite sides of the bath 2 between the front wall 7 and the rear wall 8. The bath 2 can also be enclosed by a roof or ceiling that can be connected to the rear wall 8, front wall 7, and space apart walls 6. One or more burners 3 can be positioned above the bath 2 for outputting at least one flame 15 in the atmosphere 13 within the bath 2 above the surface 9 of the metal material that is to be melted. The atmosphere 13 can be the enclosed atmosphere that is enclosed by the walls and ceiling of the bath 2.

The apparatus can also include one or more flues 11 that can be positioned so that flue gas can be passed out of the atmosphere 13 for being processed and/or emitted to the atmosphere. In some embodiments, the hot flue gas passed through the flue(s) 11 can be fed to one or more heat exchangers for use of the heat of the flue gas before the flue gas is emitted to the atmosphere. The flue gas output via the flue(s) 11 can also be treated by one or more flue gas treatment devices for removal of pollutant materials (e.g. particulates, nitrous oxides, etc.).

Each burner 3 can be a wall mounted burner or a ceiling mounted burner. Each burner 3 can be configured as an oxy-fuel burner, a transient burner with multiple burner elements, or other type of suitable burner that can output a flow of fuel that can be combusted in the presence of an oxidant (e.g. air, oxygen enriched air, etc.). The oxidant can also be output via the burner with the fuel in a pre-mixed or partial mixed flow of the fuel and oxidant, for example.

There can also be at least one sensor S positioned for detecting data related to the melting of metal material in the bath 2. Each sensor S can be positioned on, within or adjacent a wall. At least one sensor S can also (or alternatively) be positioned on, or in or adjacent a bottom 5 of the bath. At least one sensor S can also (or alternatively) be positioned on, or in or adjacent a ceiling or roof of the bath. Each sensor S can be communicatively connected to a controller CTRL for providing sensor data to the controller CTRL.

As may best be appreciated from FIGS. 1 and 10, the controller CTRL can be a computer device 20 that includes a processor CP communicatively connected to a non-transitory memory M and at least one transceiver TRCVR. The memory M can store code thereon that can be executed by the processor CP. The memory M can also store at least one application App and/or at least one data store DS thereon. The application can be run by the processor and the code run by the processor can utilize data from one or more of the data stores DS. The data stores can include files, databases, or other types of data stores.

The controller CTRL can be communicatively connected to the sensor(s) S as well as at least one valve V via communicative connections CC between the controller CTRL and these process control elements. Each valve V can be adjustable to control a flow rate of fuel and/or oxidant to one or more burners 3. The controller can also be communicatively connectable to the burner(s) 3 for adjustment of one or more valves of the burner(s) and/or other elements of the burner(s) 3 for controlling operation of the burner(s) 3.

The controller CTRL can also be communicatively connected to one or more computer devices (e.g. one or more input devices, one or more output devices, or one or more other types of computer devices 20, etc.). In some embodiments, the controller CTRL can be configured as an operator device that can provide a graphical user interface (GUI) to a user to facilitate receipt of input from the operator and also provide output to the operator to provide notifications, warnings, or other data about the operation of the apparatus 1 to the operator. In other embodiments, the controller CTRL can be communicatively connected to the operator device (which can be a type of computer device 20) to provide data to the operator device for generation of a GUI to the operator. The GUI or data provided to generate the GUI can include data that can provide output to an operator to provide notifications related to operations of the apparatus 1 and/or burners 3, request confirmation for certain processing adjustments to be provided by operator input that responds to the notification(s) and/or facilitate the providing of output to an operator and/or receipt of input from the operator for use in controlling or adjusting operations of the apparatus 1 and/or the burner(s) 3.

As discussed further herein, the controller CTRL can also provide data collected via sensor(s) S and other elements to a control evaluation device HST via a communicative connection CC between the controller CTRL and the control evaluation device HST. The control evaluation device HST can be a computer device 20 that includes a processor CP communicatively connected to a non-transitory memory M and at least one transceiver TRCVR. The memory M can store code thereon that can be executed by the processor CP. The memory M can also store at least one application App and/or at least one data store DS thereon. The application can be run by the processor and the code run by the processor can utilize data from one or more of the data stores DS. The data stores can include files, databases, or other types of data stores. The control evaluation device HST can also be communicatively connected to one or more computer devices (e.g. one or more input devices, one or more output devices, or one or more other types of computer devices 20, etc.).

The control evaluation device HST can have at least one pre-defined control evaluation scheme defined by code that can be run by its processor to evaluate stored data received from the controller CTRL and/or other control system elements (e.g. sensors S, etc.) to evaluate that data for use in evaluating whether one or more control parameters of the controller CTRL should be adjusted or updated.

As may best be appreciated from FIGS. 2-9, the controller CTRL and sensor(s) S can be configured to control the formation and adjustment of flame(s) 15 output via burner(s) 3 during the melting of metal material from an entirely solid state SLD to an entirely liquid state LQD. When the metal material is in an entirely solid state SLD, it can be in a pile in the bath 2 that may have at least one apex of height that may be a tallest surface 9tall of an upper surface 9 of the metal material within the bath 2. When the metal material is entirely solid, it can be a new batch of metal material to be melted that is entirely solid. In the event a small portion of liquid metal from a prior batch remains in the bath 2, the metal material may still be considered entirely solid because the new batch added for melting is entirely solid and makes up a majority of the metal to be melted in the bath. The small portion of liquid metal from a prior batch that may remain in such situations can be dependent on the furnace and burner configuration that may be utilized. In some embodiments, this remaining small portion of molten material (if present) can be greater than 0 weight percent (wt %) of the metal material in the bath to less than 30 wt % of the metal material in the bath, between 0 wt % and 20 wt % of the metal material in the bath, or between 0 wt % and 10 wt % of the metal material in the bath.

The upper surface 9 can be a surface of the metal material that faces toward the ceiling of the bath 2, for example. The exemplary pile of solid state SLD metal material in bath 2 shown in FIGS. 2, 6, and 8 are exemplary. Other piles of such solid state SLD metal material in other embodiments can have other shapes or configurations (e.g. non-uniform pile that has multiple peaks, a more half-oval shaped pile, etc.).

When the metal material is an entirely liquid state LQD, the upper surface 9 of the metal material can be level, or flat (e.g. have no inclination or declination, be relatively level or flat (e.g. within 3° of being flat or level, etc.). The entirely liquid state LQD of the metal material can result in the upper surface 9 of the metal material having a substantially uniform height 9u, for example (e.g. a height that is consistent with no peaks 9peak or valleys 9val or no significant difference in height, etc.).

During heating of the metal material, the burner(s) 3 can be adjusted in operation to adjust the flame(s) 15 that are output from the burner(s) 3. The flame adjustment can adjust how long a flame is, where the flame is directed, and/or a combination of these parameters. The flame adjustment can be provided via controlling how a flow of fuel and/or a flow of oxidant is output from the burner(s) and/or controlling an orientation of the burner (e.g. via mechanical motion of the burner to alter its orientation via pivoting, rotation, etc.).

For example, the burners can be operated to adjust their operational states from a first mode of operation to a second mode of operation in which the flame(s) output from the burner(s) 3 are adjusted from the first mode to the second mode to move the flame(s) away from the metal material to be melted in conjunction with the adjustment from the first mode of operation to the second mode of operation. In other embodiments, the adjustments can include other adjustments (e.g. from a second mode of operation to a third mode of operation). For example, the burner(s) 3 can be adjusted from a first mode of operation to a second mode of operation, from the second mode of operation to a third mode of operation, and from the third mode of operation to a fourth mode of operation. Each adjustment in the mode of operation can be performed to redirect the flame(s) output from the burner(s) 3 to move the flame(s) away from more liquified metal and direct the flames to either a solid portion of the metal material to be melted or to a position that is directed away from the metal material to help limit any type of metal burning that could occur via the melting process while also improving the effective utilization of the flame(s) to heat the metal material for melting of that material to an entirely liquid state LQD.

For example, as may be seen from FIGS. 2, 6, and 8, one or more flames 15 that can be output from one or more burners 3 can be directed to metal material in a solid state SLD that is in a bath 2. The flame(s) 15 can be directed to the metal material so that at least one of the flames is directed to the surface 9 of the metal material. The surface 9 can include a highest portion 9tall of the surface. In some configurations, the end of each flame 15 can be in close proximity to the surface 9 and/or in contact with the surface 9 of the solid material without risk of burning of the metal because the metal is in a solid state SLD and it has a high tolerance for being heated without burning or oxidation of the metal occurring. For instance, the distal end of a flame 15 can be in direct contact with solid state SLD metal material or can be positioned within 2 meters, within 1 meter, or within 0.5 meters of the solid state SLD metal material (e.g. a distance of between greater than 0 meters and 0.5 meters from the solid state SLD metal material, a distance of between greater than 0 meters and 0.1 meters from the solid state SLD metal material, a distance of between greater than 0 meters and 2 meters from the solid state SLD metal material, a distance of between greater than 0 meters and 1 meter from the solid state SLD metal material, a distance of between greater than 0 meters and 1.5 meters from the solid state SLD metal material, a distance of 0-2 meters from the solid state SLD metal material, a distance of 0-1 meters from the solid state SLD metal material, a distance of 0-0.5 meters from the solid state SLD metal material, etc.)

The distal end of the flame and distance the distal end of the flame has to the solid state metal material can also be determined based on input material. For example, this type of input material description can be saved in a historian that is accessible to a controller that controls the burner operations to control the size and direction of the flame(s) 15 to have the distal end of the flame(s) 15 at a pre-selected distance from the solid state metal material. A material description can be any combination of size, shape, alloy, type, impurities, etc., or any other value that can describe the metal material. For example, the distance between the distal end of a flame 15 and the solid state material can be adjusted so that for larger sized pieces of material there is a smaller distance between the distal end of the flame and material as compared to smaller size pieces of solid material because the smaller material may have a higher probability of burning than the larger material. The larger pre-selected distance can be selected to account for such a possibility to help facilitate improved heating and melting while also avoiding the burning of the metal material.

The pre-selected distance between the distal end of the flame(s) 15 and the solid state metal material can also be based on other sensor data or criteria. For example, a detected current temperature of the material (or by proxy time in a current firing/melting mode) can be utilized to adjust the distance between the distal end of the flame(s) 15 and the solid state metal material. As the material approaches its melting point it can be more susceptible to burning and therefore the distance between the distal end of the flame(s) 15 and the solid state material can be controlled so that this distance increases to greater values as the metal material melts (e.g. the distance between the distal end of the flame and the solid state metal material can be smallest when the heating of the solid metal material starts and can be increased to be a be a greater distance as the material heats and gets closer in temperature to its melting temperature).

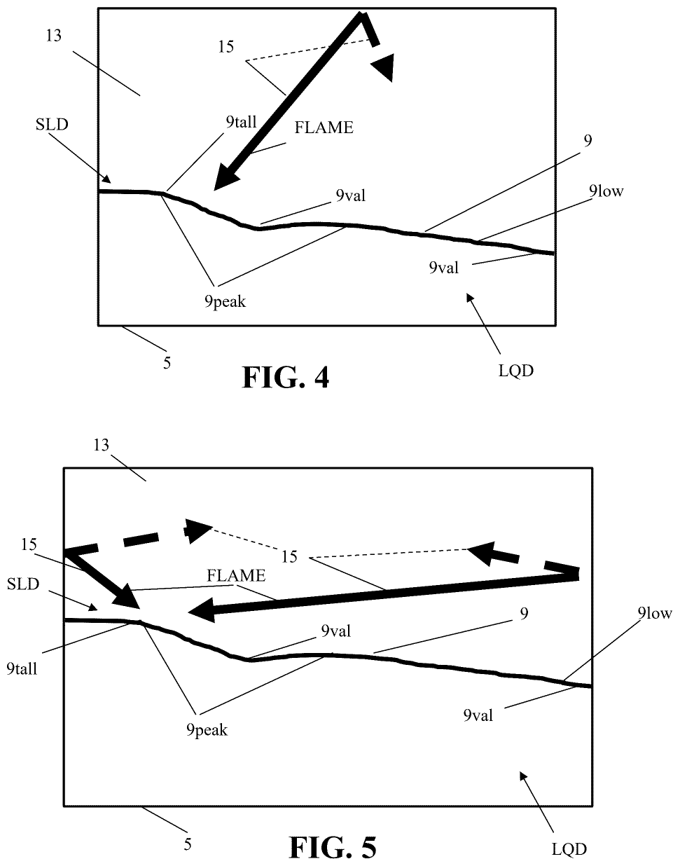

As the heating progresses, the metal material will melt and begin to liquify. In this type of intermediate stage of the melting process, the metal material can include solid state SLD metal material as well as liquid state LQD metal material. FIGS. 4 and 5 illustrate examples of such intermediate melting stages of the metal material in which a portion of the metal material is in a liquid state LQD and another portion of the metal material in in a solid state SLD. In a first intermediate melting stage that may be between the initial process in which the metal material is entirely in a solid state SLD and a second intermediate stage of the melting process, the portion of the metal material that is in the liquid state LQD can be a smaller component of the metal material as compared to the size of the portion of the metal material that is in the liquid state LQD during the second intermediate melting stage (e.g. as the melting progresses, the proportion of the metal material that is in the liquid state LQD can increase so less material in the solid state SLD is present until the entirety of the metal material is melted and in a liquid state LQD). In such intermediate stages of the melting process, we have determined that the metal material can have an upper surface 9 that has varying heights and is non-uniform in height (e.g. has multiple peaks 9peak of different heights and lower valleys 9val of different heights). For example, the upper surface 9 can include a highest portion 9tall and a lowest portion 9low as well as multiple peaks 9peak of different heights and at least one low valley 9val between the peaks 9peak. We determined that the liquid state of the metal material will typically flow onto a bottom 5 of the bath 2 and be at a lowest position in the bath 2 as the metal material melts such that the liquid metal material can be found at the lowest portion 9low of the upper surface 9. We determined that the solid state SLD metal material can remain in a higher position within the bath 2 and be found at a highest portion 9tall of the upper surface 9.

As the metal material melts, the height of the highest portion of the upper surface 9 can decrease as the liquid state metal material will be more compactly retained within the bath 2. After the metal material is fully melted so that the metal material is entirely liquid (e.g. is entirety in a liquid state LQD), the upper surface 9 of the metal material can have a uniform profile 9u as shown in FIGS. 3, 7, and 9. We have determined that when the upper surface 9 has a uniform profile 9u, the metal material may not have a tallest portion 9tall or a lowest portion 9low. Instead, the entirety of the upper surface 9 of the metal material within the bath 2 can be at the same height in the bath 2 or be about the same height in the bath 2 (e.g. there may only be slight variations in height of the upper surface of a minimal degree, such as a variance of less than or equal to 8 cm, less than or equal to 2 cm, a variation in height that can result in a variance of height of less than or equal to 3 degree angle of inclination from the lowest point of the liquid state LQD metal material and the highest point of this material in the batch 2, etc.).

The specific profile of the metal material in its liquid state LQD within the bath can be dependent upon the geometry and configuration of the bath 2. The uniform profile can be a situation where there is a tallest portion 9tall and a lowest portion 9low and there is a slight variation between these portions of a minimal degree of inclination or declination. For example, a tallest portion 9tall can be at a position that is less than or equal to 3 degrees of inclination relative to a lowest portion, may be a position that is less than or equal to 5 degrees of inclination relative to the lowest portion 9low, or may be another pre-selected definition for a uniform profile that accounts for the size and shape of the bath 2.

During the melting process, at least one sensor 2 can be utilized to monitor the metal material 2 within the bath to determine when it has begun to sufficiently melt such that the burner(s) should be adjusted in operation to adjust a direction of the flame(s) 15. For example, an ultrasound sensor 2 can be utilized to detect the shape and profile of the upper surface 9 of the metal material to determine when the surface has sufficiently changed to indicate that the melting has occurred. Such a detection can be determined based on a detection of the profile of the metal material changing from where a tallest portion 9tall of the upper surface may move away from being at an apex location that exists at an initial starting of the melting process or upon a detection that the upper surface has sufficient irregularities in height to indicate that the melting has progressed sufficiently for an adjustment in the flame(s) to occur to help avoid burning of the metal material.

The detection can also, or alternatively, include use of imaging via at least one camera (e.g. an infrared camera or other camera) to monitor the changing of the upper surface 9 for triggering an adjustment in the burner operation to adjust the flame(s). The detection can also, or alternatively include use of a pressure sensor and/or temperature sensor for detection of sufficient heat or pressure indicating of melting of the metal. As yet another example, the sensor 2 can include use of a bubbler that can detect liquid bubbling in the bath 2 for determining a sufficient amount of melting of metal has occurred for adjustment of burner operation for adjusting the flame(s) output from the burner(s) 3.

The detection can also, or alternatively, include use of one or more sensors 2 to determine a weight distribution of the metal material in the furnace and/or pressure distribution of the furnace via one or more sensors. As the weight distribution or pressure distribution may become more uniform, more melting can be detected to indicate an adjustment in burner operation is warranted.

In some embodiments, a camera, laser, and/or ultrasonic sensor can be utilized as at least one sensor S to measure or monitor a surface of the metal material in the bath 2 (e.g. measure or monitor the upper surface of the metal material in the bath 2 and/or how that surface may change over time during melting operations) to detect changes in the surface of the metal material to detect at least a partially melted state of the metal material MM and/or detect a state of the metal material in which it is entirely liquid. Such a detection can be based at least one part on evaluating how the surface may change over a period of time (e.g. changes in the detected surface occur less frequently or become more uniform, surface changes are detected as being within a pre-selected change parameter, the detected surface is determined to have a profile that meets or is within a pre-selected profile, etc.). In response to such a detection, the metal material can be determined to be in at least a partial liquid state or in an entirely liquid state.

The use of one or more sensors 2 can include use of a combination of data from different sensors being provided to a controller CTRL to evaluate the sensor data and determine a sufficient melting of metal has occurred to trigger an adjustment in burner operation. The material state change determinations can be based on either absolute changes or changes in the trends of the measurement data provided to the controller CTRL via the sensor(s). The controller can include a determination methodology that is defined by code stored in memory of the controller CTRL that defines a method by which the controller determines when burner adjustment is needed. The controller CTRL can then trigger that adjustment of the burner operation via communications with the burner 3, valve(s) V that can supply oxidant and/or fuel to the burner 3, a positional adjustment mechanism of the burner 3, and/or communication with other process control elements for adjustment in operation of the burner 3. Such actions by the controller CTRL can occur automatically or after receipt of a confirmation input from an operator. In the event confirmation input from an operator may be needed, the controller can output data for being provided to the operator via a display device or operator device to facilitate receipt of such input (e.g. via a display of a notification prompt for receipt of the input, etc.).

Some embodiments of the controller CTRL can utilize one or more sensors 2 that can facilitate a detection of one or more parameters related to the material state change of the metal material. For example, one or more sensors can detect taller and shorter regions of metal material in the furnace (e.g. via a detection of a weight distribution of the metal material in the furnace, ultrasound detection of the surface of the metal material being melted, pressure measurements, use of a laser or other optical sensor to detect a height distribution of the metal material in the furnace, ultrasound detection of the metal material to detect the heights of different regions of the metal material in the furnace, camera(s) to optically determine surfaces of the metal material in the furnace, and/or a combination of these sensor approaches, etc.). Data from one or more sensors 2 can be provided to the controller CTRL to evaluate the sensor data based on a pre-defined evaluation scheme defined by code or an application that the controller CTRL can run for use in detection of a material state change to trigger actuation of an adjustment burner operation for burner(s) and/or burner elements. For example, the pre-defined evaluation scheme can be defined by code accessible to a processor of the controller for running that code in which the code defined at least one a static model and/or at least one machine learning model. A machine learning model can include a convolutional neural network (CNN) and\or other neural network(s) for image processing and/or classification, for example. Other types of machine learning models can also be utilized (e.g. a clustering and/or regression model for data processing and prediction, etc.). In response to a detected material state change that is based on the sensor data and/or model, the controller CTRL can actuate adjustment in operation of the burner(s) and/or burner elements.

For example, in some embodiments the controller CTRL can determine that the metal material has entirely melted or is at least partially melted via utilization of a pre-defined model that is stored in its non-transitory memory and run via its processor. The model may utilize sensor data from one or more sensors S (e.g. temperature sensor(s), camera, laser, ultrasonic sensor, etc.) to predict when the metal material is at least partially melted or entirely melted for actuating adjustment in burner operation (e.g. movement of one or more flames F, ceasing of outputting of a flame F via a burner B, etc.) The predictive model can be utilized to facilitate the determining of the melting of the metal material by the controller for control of the burner(s) B or other metal melting operational parameters.

The controller CTRL can adjust the operational modes of the burners between multiple states to adjust the direction of the flame(s) and/or size and heat input of the flame(s) and/or equivalence ratio in response to the detected level of melting of the metal material. Examples of such adjustments are further discussed herein and can also be appreciated from FIGS. 2-9.

For example, in a first mode of operation in which the metal material is determined to be entirely in a solid state SLD, the flame(s) 15 can be directed to the metal material for impingement on the material (e.g. direct contact) and/or being in close proximity to the metal material. Examples of such flame(s) can be seen from the examples of FIGS. 2, 6, and 8. As may be appreciated from the broken line illustration of the flame(s) 15, there can be a single flame 15 or multiple flames 15 directed at the metal material in the bath 2. The flame(s) can be directed from at least one ceiling mounted burner 3 and/or one or more sidewall mounted burners 3 that can direct the flame(s) 15 downwardly into the batch 2 to be directed at the metal material in the bath. This type of direction of elongation of the flame(s) along the flame length of the flame(s) can include a flame 15 being elongated along a flame length that can extend to the upper surface 9 of the metal material or in close proximity to that upper surface. For example, at least one flame 15 can extend substantially vertically (e.g. via a ceiling mounted burner) and/or at least one flame can be declined to be directed at an angle of declination from a sidewall mounted burner 3 to the upper surface 9 of the metal material along an angle of declination toward the upper surface 9 of the metal material (e.g. an angle of between 15° and 75° relative to horizontal, and angle of between 30° and 60° relative to horizontal, etc.).

After melting of the material is determined to have occurred to indicate that the metal material is no longer entirely solid state SLD material, a second state of the metal material can be detected that includes the metal material including solid state SLD material as well as liquid state LQD material. The operation of the burner(s) 3 can be adjusted from a first mode of operation to a second mode of operation in response to such a detection to alter the direction and/or size of the flame(s) 15. For example, the controller CTRL can detect such an occurrence via sensor data as discussed above and communicate with valve(s) V, at least one positional adjustment mechanism of each burner 3 and/or other elements to adjust the direction of the flame(s) 15 and/or size of the flame(s) to move the distal end of the flames away from the liquid state LQD portion of the metal material and direct the flame to a detected portion of the upper surface 9 of the metal material that may still be in a solid state SLD. In embodiments where the flame 15 extends vertically, this can result in tilting of the flame 15 toward the tallest portion 9tall of the upper surface. In situations where a flame is directed at an angle of declination, this can include adjustment in the length and angle of declination of the flame(s) 15 to direct the flame toward the tallest portion 9tall of the upper surface 9.

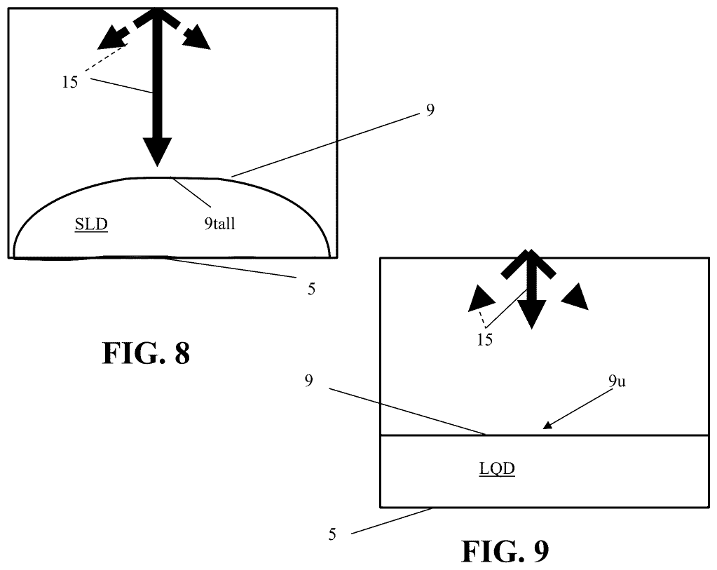

For example, a tallest portion 9tall of the upper surface 9 can be detected via the sensor data and the burner operation can be adjusted so that the flame(s) 15 are directed to the tallest portion 9tall and away from a lowest portion of the upper surface 9low. An example of such an adjustment can be appreciated from FIGS. 4 and 5, for example. In situations where at least one flame 15 is not already directed at the upper surface 9 (e.g. example of FIG. 8 in which broken line illustrated flames 15 are directed sidewardly away from the upper surface 9 of the metal material), those flame(s) can also be adjusted to provide a desired level of heat into the bath for facilitating melting of the metal material in the bath 2 in combination with adjustment of the flame(s) that are directed toward the upper surface 9.

In some embodiments, the melting of the metal material can be detected as further progressing to another more molten state in which a greater proportion of the metal material is in a liquid state LQD. Such a detection can be based on the sensor data provided to the controller CTRL as discussed above, for example. The mode of operation of the burner(s) 3 can be adjusted from a second mode of operation to a third mode of operation in response to such a detected change via the controller CTRL communicating to the different process elements of the apparatus 1 as discussed above (e.g. via one or more valves V, at least one burner 3, burner positional adjustment mechanism(s), etc.).

For instance, the controller CTRL can detect such an occurrence via sensor data as discussed above and communicate with valve(s) V, at least one positional adjustment mechanism of each burner 3 and/or other elements to adjust the direction of the flame(s) 15 and/or size of the flame(s) to move the distal end of the flames away from the liquid state LQD portion of the metal material and direct the flame to a detected portion of the upper surface 9 of the metal material that may still be in a solid state SLD. In embodiments where the flame 15 extends at an angle of declination or a tilted angle relative to vertical, this can include adjustment in the length and angle of declination of the flame(s) 15 and/or adjustment in the angle of tilting relative to vertical and/or size of the flame 15 to direct the flame toward the tallest portion 9tall of the upper surface 9.

For example, a tallest portion 9tall of the upper surface 9 can be detected via the sensor data and the burner operation can be adjusted so that the flame(s) 15 are directed to the tallest portion 9tall and away from a lowest portion of the upper surface 9low. An example of such an adjustment can be appreciated from FIGS. 4 and 5, for example. In situations where at least one flame 15 output from the burner(s) 3 is not already directed at the upper surface 9 (e.g. example of FIG. 8 in which broken line illustrated flames 15 are directed sidewardly away from the upper surface 9 of the metal material), those flame(s) can also be adjusted to provide a desired level of heat into the bath for facilitating melting of the metal material in the bath 2 in combination with adjustment of the flame(s) that are directed toward the upper surface 9.

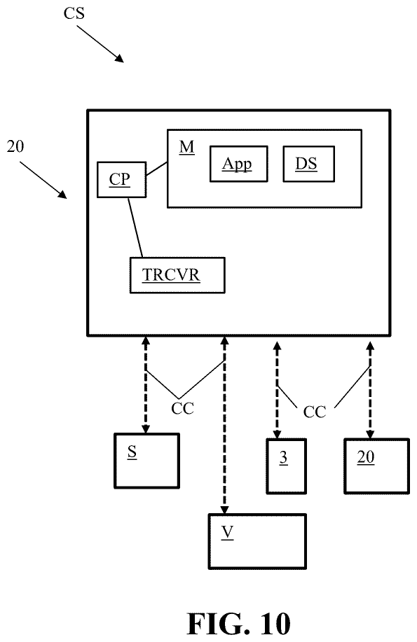

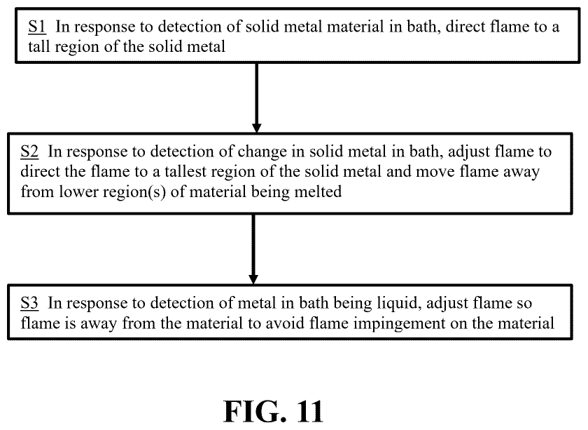

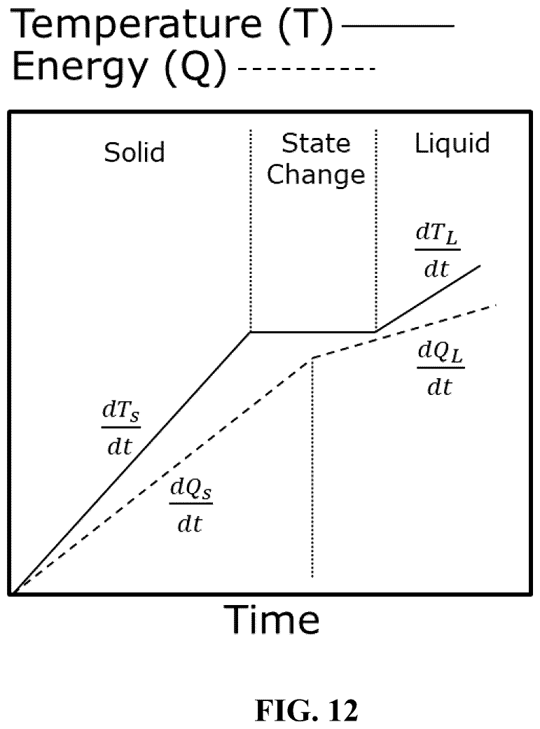

After melting of the material is determined to have occurred to indicate that the entirety of the metal material is in a liquid state LQD, a final state of the metal material can be detected that includes the entirety of the metal material being in a liquid state LQD. The operation of the burner(s) 3 can be adjusted from a second or third mode of operation to a final mode of operation in response to such a detection to alter the direction and/or size of the flame(s) 15. For example, the controller CTRL can detect such an occurrence via sensor data as discussed above and communicate with valve(s) V, at least one positional adjustment mechanism of each burner 3 and/or other elements to adjust the direction of the flame(s) 15 and/or size of the flame(s) to move the distal end of the flames away from the upper surface 9 of the metal material so that the flame is no longer in close proximity to any portion of the upper surface and/or is directed away from the upper surface. In embodiments where the flame 15 extends vertically, this can result in tilting of the flame 15 away from the upper surface and/or reducing a length of the flame so that a distal end of the flame is a substantial distance from the upper surface 9 to avoid burning of the metal material (e.g. is a distance of at least greater than 0 meters to 0.5 meters from the upper surface, a distance of at least 1 meter from the upper surface, a distance of at least 2 meters from the upper surface, etc.). In situations where a flame is directed at an angle of declination, this can include adjustment in the length and angle of declination of the flame(s) 15 to direct the flame so it extends horizontally or at an angle of inclination so that the flame(s) are directed parallel to the upper surface 9 or are directed upwardly away from the upper surface 9 of the metal material in the bath 2. Examples of this type of adjustment can be appreciated from FIGS. 3 and 7 in which flame(s) 15 are adjusted to extend horizontally and FIGS. 3 and 9 in which flame(s) are adjusted to have a substantially smaller length to be positioned sufficiently far away from the upper surface 9 so that the distal end of each flame is at least greater than 0 meters away from the upper surface 9 and is in a position in which the flame 15 is unable to burn the metal material in the bath 2 (e.g. is at least 0.1 meters away from the upper surface, is at least 0.5 meters away from the upper surface, is at least 1 meter away from the upper surface, is at least 2 meters away from the upper surface, etc.).

A further example of such an adjustment in which a flame is adjusted away from the upper surface 9 of the metal material can be appreciated from the broken line images of the flames 15 in FIG. 5. The broken line images of the flames 15 can illustrate an example of an adjustment of the flames 15 so that each flame is adjusted to extend away from the upper surface 9 of the metal material at an angle of inclination away from the upper surface (as shown in the broken line images of FIG. 5 for the flames). Prior to such an adjustment, the flames 15 could have had a position similar to that shown in solid line in FIG. 5.

Yet another example of an adjustment in operation of the burner(s) 3 that can adjust the flame(s) 15 can be seen from the example of FIG. 4 in which the flame 15 is adjusted from being elongated and directed to a tallest region 9tall of the upper surface 9 (as shown in the solid line illustration of the flame 15) to a position that is moved away from the upper surface (as shown by the broken line image of the flame 15 in FIG. 4) by shortening of the length of the flame and moving the flame away from the upper surface to a position that is tilted so that the distal end of the flame is sufficiently far away from the upper surface to avoid burning of the metal material.

During melting of the metal material, the controller CTRL can be configured to control operation of the burner(s) and/or burner element(s) 3 so that the burner(s) and/or burner element(s) operate within a pre-selected range of equivalence ratios and/or firing rates. The operational ranges can be different for different burners and/or burner elements as well.

For instance, the equivalence ratio for burner(s) and/or burner element(s) located closer to the metal material to be melted in a bath can range from 0.5 to 5, 0.95 to 5 or 1 to 3.75 in different embodiments. At the beginning of a melt operation (e.g. at an initial phase in which the metal material is solid state), a higher equivalence ratio may be utilized for such burner(s) and/or burner element(s) (e.g. an equivalence ratio of 5, 3.75, or other value at a higher end of a pre-selected operational range of equivalence ratios). At the end of a melt operation in which the metal material is liquified, a lower equivalence ratio may be utilized (e.g. an equivalence ratio of 0.5, 0.95, 1.0, or other value at a lower end of a pre-selected operational range of equivalence ratios).

For burner(s) and/or burner element(s) that are farther away from the metal material to be melted (e.g. closer to a roof of the bath, etc.) the equivalence ratio for the burner(s) and/or burner element(s) can range from 0.1 to 1, 0.25 to 1 or 0.2 to 1 in different embodiments, for example. At the beginning of a melt operation (e.g. at an initial phase in which the metal material is solid state), a lower equivalence ratio may be utilized (e.g. an equivalence ratio of 0.1, 0.2, 0.25, 0.36, 0.4, or other value at a lower end of a pre-selected operational range of equivalence ratios). At the end of a melt operation in which the metal material is liquified, a higher equivalence ratio may be utilized (e.g. an equivalence ratio of 1, 0.9, 0.95, or other value at a higher end of a pre-selected operational range of equivalence ratios).

The controller can adjust parameters so that the burners and/or burner elements 3 can also be operated such that the equivalence ratio of all burner(s) and/or burner elements utilized in the melting of the metal material can operate at an overall combined equivalence ratio within a pre-selected range of ratios (e.g. an overall combined equivalence ratio range of 1-1.1, 0.9-1.2, 0.95-1.15, etc.). The selected operational equivalence ratios can be selected to account for bath and furnace configurations, fuel to be combusted, the type of metal material to be melted, and the presence of any combustible contaminants.

Burner and/or burner element firing rates can also be pre-selected to account for where the burner(s) and/or burner elements are located relative to the material to be melted and other design and operational objectives. For instance, for burner(s) and/or burner element(s) located closer to the metal material to be melted in a bath, their firing rate allocation can be within a pre-selected range of 10%-90%, 50%-90% or 70%-80% of maximum firing rate, for example. At the beginning of a melt operation (e.g. at an initial phase in which the metal material is solid state), a higher firing rate allocation may be utilized (e.g. burning rate allocation of 70%-80%, or 50%-90%, or other value at a higher end of a pre-selected operational range of firing rate allocations). At the end of a melt operation in which the metal material is liquified, a lower firing rate allocation may be utilized (e.g. a firing rate allocation of 20%-30%, 10%-50%, or other value at a lower end of a pre-selected operational range of firing rate allocations).

For burner(s) and/or burner element(s) that are farther away from the metal material to be melted (e.g. closer to a roof of the bath, etc.) the range of firing rate allocations for such burner(s) and/or burner element(s) can range from 10% to 90%, 20%-80%, or other pre-selected firing rate allocation range in different embodiments, for example. At the beginning of a melt operation (e.g. at an initial phase in which the metal material is solid state), a lower firing rate allocation may be utilized (e.g. a firing rate allocation of 20%-30%, a firing rate allocation of 10%-50%, or other value at a lower end of a pre-selected operational range of firing rate allocations). At the end of a melt operation in which the metal material is liquified, a higher firing rate allocation may be utilized (e.g. firing rate allocation of 70%-80%, 50%-90%, or other value at a higher end of a pre-selected operational range of firing allocation ratios).

At or near the end of a melting operation in which the metal material is liquified, the firing rate may decrease further as the end of the melt operation approaches. And the firing of the burners can also, in some embodiments, be ceased after a full melt has occurred in some embodiments.

Table 1 provided below provides an additional example of exemplary pre-selected equivalence ratio ranges and burner firing rate ranges that can be utilized in different embodiments.

TABLE 1
exemplary range of equivalence ratios and firing rate ranges for a
transient burner with two or more elements or two or more burners 3

| | | Later stages of melting |
|---|---|---|
| Burner Location or | | (material is more |
| Burner Element | | liquified or fully |
| Orientation | Initial stages of melting | liquified) |
| Closer to material to | Firing rate allocation | Firing rate allocation |
| be melted | of 70%-80% | of 20%-30% |
| | Equivalence Ratio of | Equivalence Ratio of |
| | 2-3.75 | 1-2 |
| Further from material | Firing rate allocation | Firing rate allocation |
| to be melted (e.g. | of 20%-30% | of 70%-80% |
| closer to roof) | Equivalence Ratio of | Equivalence Ratio of |
| | 0.25-0.5 | 0.5-1.0 |

FIG. 11 illustrates an exemplary embodiment of a process for melting metal, which can utilize an exemplary embodiment of a process for controlling at least one flame for the melting of metal. Embodiments of the apparatus 1 and embodiment of a control system for the apparatus can be configured to utilize an embodiment of this process.

In a first step S1, solid metal can be in a bath 2 of an apparatus for being heated via at least one flame 15 generated via at least one burner 3. The solid metal material can be fed into the bath 2 and the burner(s) 3 can subsequently be started to initiate combustion of a fuel to form at least one flame 15 for heating the metal material in the bath. In response to detection of the solid metal in the bath, each flame, or at least one of the flames, can be directed to a tallest region of the upper surface 9 of the metal material in the bath for heating of the metal material that is in a solid state SLD for melting that material. Examples of such a direction of the flame(s) can be appreciated from FIGS. 3, 6, and 8.

In a second step S2, the flame(s) 15 can be adjusted to direct the flame(s) 15 to a tall region 9tall of the metal material in the solid state SLD and move flame away from lower region(s) 9low of material being melted to move the flame away from the metal material that is in a liquid state LQD. This second step S2 can include detection of at least one intermediate melting stage of the metal material for adjustment of the burner operation for adjustment of the flame(s) 15 as discussed above, for example. The second step S2 can include a single adjustment or can include multiple different discrete adjustments that account for different pre-selected or pre-defined stages of the melting process for the melting of the metal material in which a portion of the material is melted into a liquid state LQD and a portion of the material is still in a solid state SLD as discussed above. The detection of the melting stage(s) of the metal material can be provided via use of one or more sensors 2 and a controller CTRL as discussed above. The adjustment in operation of the burner(s) 3 to provide the flame adjustment can also be performed as discussed above in some embodiments.

In a third step S3, the flame(s) 15 can be adjusted so that the flame(s) move away from the upper surface of the metal material in response to detection of the metal material being entirely in a liquid state LQD. The detection of the entirely melted state of the metal material can be provided via use of one or more sensors 2 and a controller CTRL as discussed above. The adjustment in operation of the burner(s) 3 to provide the flame adjustment can also be performed as discussed above in some embodiments.

In some embodiments, the second and third steps S2-S3 can include use of a controller CTRL that can determine that the metal material has entirely melted or is at least partially melted via utilization of a pre-defined model that is stored in its non-transitory memory and run via its processor. The model may utilize sensor data from one or more sensors S (e.g. temperature sensor(s), camera, laser, ultrasonic sensor, etc.) to predict when the metal material is at least partially melted or entirely melted for actuating adjustment in burner operation (e.g. movement of one or more flames F, ceasing of outputting of a flame F via a burner B, etc.) The predictive model can be utilized to facilitate the determining of the melting of the metal material by the controller for control of the burner(s) B or other metal melting operational parameters. The controller CTRL can run the model based on the received sensor data to determine that the metal material has been melted into one or more pre-selected or pre-defined intermediate melted stages in which the metal material is no longer entirely solid, but is also not entirely liquid. Such a determination can be a prediction that is made via running the model utilizing the sensor data as noted above, for example.

Also, the controller CTRL can run the model based on the received sensor data to determine that the metal material has been entirely melted and is entirely liquid. Such a determination can be a prediction that is made via running the model utilizing the sensor data as discussed above, for example.

Embodiments of the process can also include other steps. For example, embodiments can include outputting of the metal in a liquid state for further processing. As another example, embodiments can include a controller CTRL communicating with different process elements for adjusting the flame(s) 15 as discussed above. Embodiments of the process can also include other features or steps.

The adjustment in the operation of the burner(s) 3 can adjust the length of the flame(s) 15, the direction of the flame(s) 15, and/or the firing rate of the burner(s) 3 to account for the material state of the metal material being melted to help avoid burning of the metal material while also providing improved use of the heat of the generated flame(s) 15. Embodiments can provide greater flexibility in operation for a more refined control of melting of metal to help avoid burning the metal while also improving utilization of energy so that a more efficient and flexible operation can be provided in a way that may also improve the environmental impact related to operation of the furnace and the melting of metal. Improved yield at lower overall use of energy and/or fuel can be provided, for example, which can help reduce the environmental impact associated with operations.

Control in operation of the burner(s) 3 and other elements of the apparatus 1 can also be updated to account for empirical use conditions that are observed via a control system 20 during operations. Such empirical data can be collected via sensor data and other data and provided to a control evaluation device HST. The HST can be a type of computer device 20 that can be communicatively connected to a controller CTRL for evaluation of empirical data via one or more pre-defined evaluation schemes and provide data to the controller CTRL based on such an evaluation for updating one or more control parameter settings (e.g. setpoints, thresholds, etc.) of the controller CTRL. An operator may be prompted to review and approve such an adjustment before it is implemented in the controller CTRL via a communication provided by the control evaluation device HST or the controller CTRL (e.g. via a communication provided to an operator device, via a notification provided to an operator device, etc.).

In other embodiments, the controller CTRL can be configured to store such data and evaluate such data via one or more pre-defined evaluation schemes for updating one or more control parameters or providing output to an operator for the operator to approve an updating of one or more control parameters based on the conducted evaluation of stored, empirical data.

The evaluation of empirical data and updating of control parameters can be configured to update one or more control parameters, which can include pre-selected setpoints or pre-selected thresholds for controlling (a) flow rates, (b) equivalence ratios, (c) flame position, (d) flame orientation, (e) flame mode, (f) burner and/or burner element allocation, or combinations of such parameters. The one or more control parameters can also relate to other operations of other aspects of the apparatus 1.

The data for different control parameters as well as data for other uncontrolled parameters such as but not limited to material details (size, shape, impurities, description, supplier, etc.), material amounts, starting height(s), starting height differences, liquid metal from prior cycle, ambient condition, furnace temperatures and conditions, etc. can be used to perform at least one pre-defined evaluation scheme for evaluation of performance in melting of metal and identifying control parameter changes that may be made to improve operations to account for empirical use data. Such data can include sensor data as well as other data related to melting of metal material that may be provided by other sensors or control device.

The pre-defined evaluation scheme can include one or more types of schemes. For example, a pre-defined evaluation scheme can include modeling of a

$$Solid Temperature Change over Time \frac{{dT}_{s}}{dt} , Liquid Temperature Change over Time \frac{{dT}_{L}}{dt} , Solid Energy Change over Time \frac{{dQ}_{s}}{dt} , Liquid Energy Change over Time \frac{{dQ}_{L}}{dt} ,$$

and/or other conditions. Other conditions, can include, for example, State Change Time or a percentage of overall time in which a state change occurred for a melt, Material Yield Recovery, overall melt time, an amount of time metal being melted was determined to be in different material states (solid, partially melted, fully melted, etc.), a time for each cycle in a melting process, an amount of energy utilized in each cycle of the melting process, or other modeling approaches. In some embodiments, the pre-defined evaluation scheme can utilize a single pre-defined model or a combination of multiple different models. Models can include physics-based modeling, machine learning models, a blend of these models with single or multiple x-values and y-values, or a combination of such models. Utilizing these model(s) with a control parameter search can help determine the optimal material temperature increase at each cycle step and/or temperature phase, optimal yield recovery, optimal overall melt time, reduced energy, and reduce environmental impact based on empirical metal melting data for use in updating of one or more control parameters that can be utilized by the controller CTRL.

As may be appreciated from FIG. 12, an example control model can be broken down into three or more temperature phases such as but not limited to solid, state change, and liquid. When the material is solid it can absorb more energy (Q) and is less likely to burn and create dross. The model can be defined so that a slope of solid material temperature (Ts) changing over time

$$( t ) -> \frac{{dT}_{s}}{dt} .$$

The data for this slope that can be determined can be based on the temperature data received from one or more sensors S during prior melts for a time period in which the metal material was determined to be in a solid state (e.g. prior to a change in adjustment of a burner or burner element for adjusting in flame positioning, etc.). A steep

$$\frac{{dT}_{s}}{dt}$$

slope may result in a reduced cycle time and improve energy efficiency and a gradual

$$\frac{{dT}_{s}}{dt}$$

slope (e.g. less steep slope) may result in an increased cycle time and reduce energy efficiency. A comparison of such slopes from multiple different prior melting cycles can be utilized to help identify control parameters adjustments that may allow for a quicker melt that is more energy efficient while also avoiding the burning of the metal material to be melted.

The model can also be defined so that when the material is in the state change phase, temperature (T) may change minimally as most of the energy is utilized by melting of the materials. The determination of such a phase can be based on the sensor data received from prior melts and evaluation of when the metal material being melted changed from being partially solid and partially liquid to entirely liquid (e.g. a non-significant change in temperature while the material undergoes heating or changes in the heights of the materials in the furnace (e.g. via at least one ultrasound sensor, at least one imaging sensor (e.g. at least one camera), or other type of sensor or combination of sensors (e.g. use of a temperature sensor, use at least one temperature sensor at a pre-selected position for measuring temperature at a particular location in the furnace, etc. as discussed above).). The risk of burning the metal can increase in this phase as some of the material is in the liquid phase. This condition to be monitored and evaluated can be defined as the slope of liquid material temperature (TL) changing over time

$$( t ) -> \frac{{dT}_{L}}{dt} .$$

Since the time the material is in a solid phase may be much greater than when the material is in a liquid phase, a steep

$$\frac{{dT}_{L}}{dt}$$

slope may provide little to no cycle time improvements but may increase the risk of burning aluminum and a more gradual

$$\frac{{dT}_{L}}{dt}$$

slope may decrease the risk of burning aluminum and improve yield recovery.

Another example control model that can be utilized in a pre-defined evaluation scheme can include defining two or more energy phases such as but not limited to solid energy phase and liquid energy phase wherein the state change (e.g. transition between entirely solid to entirely liquid) is split between these energy phases. When the metal material is in a solid energy phase, it can absorb more energy and is less likely to burn and create dross. This can be defined as the slope of solid material energy (Qₛ) increasing/changing over time

$$( t ) -> \frac{{dQ}_{s}}{dt} .$$

A steep

$$\frac{{dQ}_{s}}{dt}$$

slope can reduce cycle time while a more gradual

$$\frac{{dQ}_{s}}{dt}$$

slope can increase cycle time but may have other benefits.

At the end of the solid energy phase material melting has already started. At the beginning of the liquid energy phase the material is still melting but the risk of metal burning has increased. This can be defined as the slope of liquid material energy (Q_{L}) changing over time

$$( t ) -> \frac{{dQ}_{L}}{dt} .$$

Since the time the material is in a solid energy phase may be much greater than when the material is in a liquid phase, a steep

$$\frac{{dQ}_{L}}{dt}$$

slope may provide little to no cycle time improvements but may increase the risk of burning the metal material and a gradual

$$\frac{{dQ}_{L}}{dt}$$

slope may decrease the risk of burning the metal and improve yield recovery but could be dependent on other factors.

The transition between entirely solid phase to entirely liquid phase can be determined as being a period of time in which the temperature of the metal material does not substantially change while it is undergoing heating (e.g. horizontal portion of line shown in FIG. 12).

The control evaluation device can be configured to utilize the collected data from prior operations of the apparatus to model that data and identify adjustments in control parameters that may provide improved operations (e.g. improved yield and/or reduced energy consumption and/or reduced processing time, etc.) while the metal material is in the solid phase, liquid phase, or undergoing a transition from solid to liquid. For example, adjustments in one or more control parameters can be identified for reducing the

$$\frac{{dQ}_{L}}{dt}$$

slope or reducing the

$$\frac{{dT}_{L}}{dt}$$

slope. As another example, adjustments in one or more control parameters can be identified for increasing the

$$\frac{{dQ}_{s}}{dt}$$

slope or increasing the

$$\frac{{dT}_{s}}{dt}$$

slope. Such adjustments can include adjustments of control parameters that may be utilized by the controller CTRL for determining when metal material is solid, no longer entirely solid or is entirely liquid, control parameters used by the controller CTRL for controlling burner and/or burner element operation (e.g. flame size, flame direction, equivalence ratio, etc.), or other control parameters.

The detected adjustments in operational setpoints, thresholds utilized for detection of a metal material state, or other control parameters that are identified from such an evaluation can be communicated to a controller CTRL for updating those setpoints, thresholds, or other control parameters. The controller CTRL or control evaluation device HST can be configured to provide a prompt to an operator for receipt of input that approves of such a change or such changes before the controller CTRL implements the change(s). These types of control parameter adjustments can permit the adjustment in flame(s) output from the burner(s) to occur in a more efficient manner via more precise detection of the phase of the metal material and/or a more precise modeling or correlation of how adjusting the positioning of the flame(s) impacts the condition of the metal material and overall furnace operation.

Embodiments of the apparatus 1 and process can include other features or elements. For instance, embodiments of the apparatus or process can each be configured to include process control elements positioned and configured to monitor and control operations of the apparatus 1 and/or process of melting metal material (e.g. temperature and/or pressure sensors, flow sensors, optical sensors, ultrasound sensors, etc., an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can utilize a distributed control system (DCS) for implementation of one or more processes and/or controlling operations of an apparatus or process as well.

The burner(s) 3 that may be utilized in the apparatus 1 can be any type of suitable burner 3. For example, burners, oxy-fuel burners, transient burners with multiple burner elements, or a combination of such burners can be utilized. Also, the metal material to be melted can be any suitable metal. For example, the metal material to be melted can include aluminum or another type of metal or can include an alloy (e.g. brass or bronze). For example, the metal material can include aluminum, copper, lead, tin, brass, steel, iron, or other suitable metal material. Also, the size and configuration of the bath 2 can be any suitable geometry or size to meet a pre-selected set of design criteria.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a process, an apparatus, a system, and methods of making and using the same have been shown and described above, it is to be distinctly understood that the invention is not limited thereto but may be otherwise variously embodied and practiced within the scope of the following claims.

1. A process for melting metal material comprises:
directing at least one flame to metal material in a bath such that the at least one flame impinges the metal material or is within a pre-selected distance that is no greater than 2 meters from the metal material while an entirety of the metal material is in a solid state;
in response to detecting that the metal material has melted such that the metal material is at least in a partially liquid state, adjusting the at least one flame to move the at least one flame away from the metal material.

2. The process of claim 1, wherein the adjusting of the at least one flame to move the at least one flame away from the metal material comprises shortening of the at least one flame to avoid burning of the metal material, adjusting a firing rate of the at least one burner that outputs the at least one flame, and/or adjusting operation of the at least one burner so that the at least one flame extends horizontally relative to an upper surface of the metal material and above the upper surface.

3. The process of claim 1, wherein the adjusting of the at least one flame to move the at least one flame away from the metal material comprises adjusting operation of at least one burner that outputs the at least one flame such that the at least one flame extends at an angle of inclination away from an upper surface of the metal material.

4. The process of claim 1, wherein the adjusting of the at least one flame to move the at least one flame away from the metal material comprises adjusting operation of at least one burner that outputs the at least one flame so that the at least one flame extends horizontally relative to an upper surface of the metal material and above the upper surface.

5. The process of claim 1, comprising:
in response to detecting that the metal material has melted such that the metal material is in a first intermediate stage of melting in which a portion of the metal material is in a liquid state and a portion of the metal material is in a solid state, adjusting the at least one flame such that the at least one flame is moved away from a lower portion of an upper surface of the metal material and is directed toward a taller region of the upper surface of the metal material that is determined to be the portion of the metal material that is in the solid state for the first intermediate stage of melting.

6. The process of claim 5, comprising:
in response to detecting that the metal material has melted such that the metal material is in a second intermediate stage of melting in which a portion of the metal material is in a liquid state and a portion of the metal material is in a solid state, adjusting the at least one flame such that the at least one flame is directed toward a taller region of an upper surface of the metal material that is determined to be the portion of the metal material that is in the solid state for the second intermediate stage of melting; and
wherein the portion of the metal material that is in the liquid state differs in size as compared to the portion of the metal material that is in the liquid state of the first intermediate stage of melting.

7. The process of claim 1, comprising:
detecting that the metal material has melted such that the metal material is entirely in the liquid state, the detecting that the metal material has melted such that the metal material is entirely in the liquid state including a controller receiving data from at least one sensor positioned to detect the metal material has melted such that the metal material is entirely in the liquid state.

8. The process of claim 7, wherein the at least one sensor includes at least one ultrasound sensor and/or at least one camera.

9. The process of claim 7, comprising:
detecting that the metal material has melted such that the metal material is entirely in the liquid state based on determining that an upper surface of the metal material within a bath is of a uniform height.

10. The process of claim 7, comprising:
detecting that the metal material has melted such that the metal material is in a first intermediate stage of melting in which a portion of the metal material is in a liquid state and a portion of the metal material is in a solid state based on a determination that an upper surface of the metal material has changed and has a non-uniform height that includes different peaks of different heights and at least one valley between the different peaks; and
in response to detecting that the metal material has melted such that the metal material is in the first intermediate stage of melting, adjusting the at least one flame such that the at least one flame is moved away from a lower portion of an upper surface of the metal material and is directed toward a taller region of the upper surface of the metal material that is determined to be the portion of the metal material that is in the solid state for the first intermediate stage of melting.

11. An apparatus for melting metal material comprising:
a bath having a bottom, a plurality of sidewalls extending above the bath;
at least one sensor positioned to monitor metal material that is positionable in the bath to collect data related to melting of the metal material in the bath;
at least one burner posited adjacent to the bath to output at least one flame for melting of the metal material that is positionable in the bath;
a controller having a processor connected to a non-transitory computer readable medium, the controller communicatively connectable to the at least one sensor and the at least one burner;
the controller configured to
control operation of the at least one burner so that the least one flame impinges an upper surface of the metal material or is within a pre-selected distance that is no greater than 2 meters from the upper surface of the metal material within the bath while an entirety of the metal material is in a solid state;
determine that the metal material has melted such that the metal material is entirely in a liquid state based on sensor data received from the at least one sensor, and, in response to determining that the metal material is entirely in the liquid state, control operation of the at least one burner to adjust the at least one flame to move the at least one flame away from the metal material.

12. The apparatus of claim 11, wherein controller is configured to control operation of the at least one burner to adjust the at least one flame to move the at least one flame away from the metal material via shortening of the at least one flame to avoid burning of the metal material, adjusting a firing rate of the at least one burner, and/or adjusting operation of the at least one burner so that the at least one flame extends horizontally relative to the upper surface of the metal material and above the upper surface.

13. The apparatus of claim 11, wherein controller is configured to control operation of the at least one burner to adjust the at least one flame to move the at least one flame away from the metal material via adjusting operation of at least one burner so that the at least one flame extends at an angle of inclination away from the upper surface of the metal material.

14. The apparatus of claim 11, wherein controller is configured to control operation of the at least one burner to adjust the at least one flame to move the at least one flame away from the metal material via adjusting operation of at least one burner so that the at least one flame extends horizontally relative to the upper surface of the metal material and above the upper surface.

15. The apparatus of claim 11, wherein the controller is also configured so that:
in response to detecting that the metal material has melted such that the metal material is in a first intermediate stage of melting in which a portion of the metal material is in a liquid state and a portion of the metal material is in a solid state, operation of the at least one burner is adjusted such that the at least one flame is moved away from a lower portion of an upper surface of the metal material and is directed toward a taller region of the upper surface of the metal material that is determined to be the portion of the metal material that is in the solid state for the first intermediate stage of melting.

16. The apparatus of claim 15, wherein the controller is also configured so that:
in response to detecting that the metal material has melted such that the metal material is in a second intermediate stage of melting in which a portion of the metal material is in a liquid state and a portion of the metal material is in a solid state, operation of the at least one burner is adjusted such that the at least one flame is directed toward a taller region of the upper surface of the metal material that is determined to be the portion of the metal material that is in the solid state for the second intermediate stage of melting; and
wherein the portion of the metal material that is in the liquid state differs in size as compared to the portion of the metal material that is in the liquid state of the first intermediate stage of melting.

17. The apparatus of claim 11, wherein the at least one sensor includes at least one ultrasound sensor and/or at least one camera.

18. The apparatus of claim 11, wherein the controller is configured to detect that the metal material has melted such that the metal material is entirely in the liquid state based on determining that the upper surface of the metal material within the bath is of a uniform height.

19. The apparatus of claim 11, wherein the controller is configured to detecting that the metal material has melted such that the metal material is in a first intermediate stage of melting in which a portion of the metal material is in a liquid state and a portion of the metal material is in a solid state based on a determination that the upper surface of the metal material has a non-uniform height that includes different peaks of different heights and at least one valley between the different peaks based on data received from the at least one sensor; and
the controller configured to respond to detecting that the metal material has melted such that the metal material is in the first intermediate stage of melting by adjusting operation of the at least one burner such that the at least one flame is moved away from a lower portion of the upper surface of the metal material and is directed toward a taller region of the upper surface of the metal material that is determined to be the portion of the metal material that is in the solid state for the first intermediate stage of melting.

20. A control system comprising:
a controller having a processor connected to a non-transitory computer readable medium, the controller communicatively connectable to the at least one sensor and at least one burner positioned to output at least one flame to melt metal material;
the controller configured to
control operation of the at least one burner so that the least one flame impinges an upper surface of the metal material or is within a pre-selected distance that is no greater than 2 meters from the upper surface of the metal material while an entirety of the metal material is in a solid state; and
determine that the metal material has melted such that the metal material is entirely in a liquid state based on sensor data received from the at least one sensor, and, in response to determining that the metal material is entirely in the liquid state, control operation of the at least one burner to adjust the at least one flame to move the at least one flame away from the metal material.

21. The control system of claim 20, comprising:
a control evaluation device communicatively connectable to the controller, the control evaluation device having a processor connected to a non-transitory computer readable medium;
the control evaluation device configure to evaluate operational data from melting of metal material that occurred in prior melting operations based on at least one pre-defined control evaluation scheme to identify one or more control parameter adjustments and communicate data to adjust the one or more control parameters to be utilized by the controller based on results from implementation of the at least one pre-defined control evaluation scheme indicating that the one or more control parameter adjustments will improve yield, increase production, and/or reduce energy consumption for melting of the metal material.
